(19) United States
(12) Patent Application Publication
(10) Pub. No.: US 2024/0312037 A1
(43) Pub. Date: Sep. 19, 2024

(54) SLAM DEVICE, COMPUTER READABLE MEDIUM, AND AUTONOMOUS MOBILITY

(71) Applicant: Mitsubishi Electric Corporation, Tokyo (JP)

(72) Inventor: Masashi FUKUNAGA, Tokyo (JP)

(73) Assignee: Mitsubishi Electric Corporation, Tokyo (JP)

(21) Appl. No.: 18/678,995

(22) Filed: May 30, 2024

Related U.S. Application Data
(63) Continuation of application No. PCT/JP2022/002458, filed on Jan. 24, 2022.

(51) Int. Cl. G06T 7/579; G01S 7/495; G01S 17/86; G01S 17/89; G06T 7/73

(52) U.S. Cl. CPC G06T 7/579; G01S 7/495; G01S 17/86; G01S 17/89; G06T 7/74; G06T 2207/10028; G06T 2207/30252

(57) ABSTRACT

A SLAM device (200) performs SLAM using first three-dimensional point cloud data based on measurement point cloud data from a LiDAR sensor (101). The SLAM device recognizes a feature object in an image indicated in image data from a camera (102), and calculates a relative distance from the camera to the feature object. The SLAM device superimposes a three-dimensional point cloud indicated in second three-dimensional point cloud data based on the image data onto the generated map so as to calculate a comparative distance from an estimated location on the map to the feature object, and when a difference between the comparative distance and the relative distance is a value outside an allowable range, performs interpolation for the SLAM using the second three-dimensional point cloud data.

### CROSS REFERENCE TO RELATED APPLICATIONS

This application is a Continuation of PCT International Application No. PCT/JP2022/002458, filed on Jan. 24, 2022, all of which are hereby expressly incorporated by reference into the present application.

### TECHNICAL FIELD

The present disclosure relates to countermeasures against attacks on SLAM.

### BACKGROUND ART

SLAM is a technology that simultaneously estimates a self-location and constructs an environmental map.

SLAM constructs a map based on surrounding environmental data and simultaneously projects a self-location onto the map. As a result, the map is updated in real time.

SLAM can create a map and estimate a self-location in environments not only outdoors but also indoors.

SLAM is an abbreviation for simultaneous localization and mapping.

SLAM is performed using ranging data obtained from a sensor such as LiDAR.

LiDAR is a ranging device that uses near-infrared light to measure a distance to an object or a surrounding environment.

The main measurement principle of LiDAR is direct ranging. For direct ranging, a principle called ToF is used.

ToF is a method of calculating a distance based on the time it takes for light to travel back and forth between an object and a sensor.

LiDAR is an abbreviation for light detection and ranging.

ToF is an abbreviation for time of flight.

SLAM is used for automated driving systems.

An automated driving system is a system that does not involve human eyes, and is installed in mobility such as a fully self-driving car and an automated guided vehicle.

Light injection attacks on SLAM are known.

Light injection attacks can be a fatal problem in automated driving systems.

This attack emits laser light toward LiDAR. This corrupts a map created by SLAM. The map is generated in a later stage of signal processing on the laser light, but this attack is possible even of a Kalman filter is used in the later stage of signal processing.

An attack on SLAM disrupts the operation of mobility in which an automated driving system is installed.

A conceivable solution for this problem is to compare two maps created by SLAM (the current map and the past map) so as to find a part missing in one of the maps and supplement the missing part.

However, the mobility moves. For example, a car traveling at 50 kilometers per hour advances about 14 meters per second. Therefore, if a comparison of maps takes time, this solution is not practical. It is desirable that a comparison of maps be completed in a shorter time than the interval required for updating a map.

Patent Literature 1 discloses a technology that can be used as a countermeasure against attacks on SLAM. Specifically, a method is disclosed in which a self-location is estimated by each of a plurality of SLAM algorithms and the actual self-location is determined based on a plurality of estimated self-locations.

Specifically, the SLAM algorithms are an algorithm for SLAM using a camera and an algorithm for SLAM using LiDAR. SLAM using a camera is called visual SLAM.

Visual SLAM executes processing in two steps which are image recognition and SLAM execution. Therefore, the processing time of visual SLAM is long.

### CITATION LIST

### Patent Literature

Patent Literature 1: JP 2020-160594 A

### SUMMARY OF INVENTION

### Technical Problem

An attack on SLAM can disrupt the operation of mobility in which an automated driving system is installed. The existing technology has a technical problem in solving this problem. Specifically, the problem is that processing for a countermeasure takes time, making it impossible to meet the requirements of an automated driving system. The reason for this is that attacks on SLAM are newly proposed attacks, and countermeasures have not been fully established.

An object of the present disclosure is to make it possible to shorten the time required for implementing a countermeasure against an attack on SLAM.

### Solution to Problem

A SLAM device of the present disclosure is installed in autonomous mobility equipped with a LiDAR sensor and a camera.

The SLAM device includes
a point cloud processing unit to acquire measurement point cloud data from the LiDAR sensor, generate first three-dimensional point cloud data based on the measurement point cloud data, and perform SLAM using the first three-dimensional point cloud data so as to estimate a location and generate a map;
an image processing unit to acquire image data from the camera, recognize a feature object in an image indicated in the image data, calculate a distance from the camera to the feature object as a relative distance, and convert the image data into second three-dimensional point cloud data; and
an attack detection unit to superimpose a three-dimensional point cloud indicated in the second three-dimensional point cloud data onto the generated map so as to calculate a distance from the estimated location on the map to the feature object as a comparative distance, compare the comparative distance with the relative distance, and when a difference between the comparative distance and the relative distance is a value outside an allowable range, perform interpolation for the SLAM using the second three-dimensional point cloud data.

### Advantageous Effects of Invention

According to the present disclosure, it is possible to detect an attack on SLAM by superimposing a three-dimensional point cloud obtained from image data onto a map, and implement a countermeasure (interpolation) using the three-dimensional point cloud. As a result, it is possible to shorten the time required for a countermeasure against an attack on SLAM.

### BRIEF DESCRIPTION OF DRAWINGS

FIG. 1 is a configuration diagram of autonomous mobility 100 in Embodiment 1;

FIG. 2 is a configuration diagram of a SLAM device 200 in Embodiment 1;

FIG. 3 is a functional configuration diagram of the SLAM device 200 in Embodiment 1;

FIG. 4 is a flowchart of a SLAM attack countermeasure method in Embodiment 1;

FIG. 5 is a figure illustrating an example of a hardware configuration of the autonomous mobility 100 in Embodiment 1; and

FIG. 6 is a hardware configuration diagram of the SLAM device 200 in Embodiment 1.

### DESCRIPTION OF EMBODIMENTS

In the embodiment and drawings, the same elements or corresponding elements are denoted by the same reference sign. Description of an element denoted by the same reference sign as that of an element that has been described will be omitted or simplified as appropriate. Arrows in figures mainly indicate flows of data or flows of processing.

### Embodiment 1

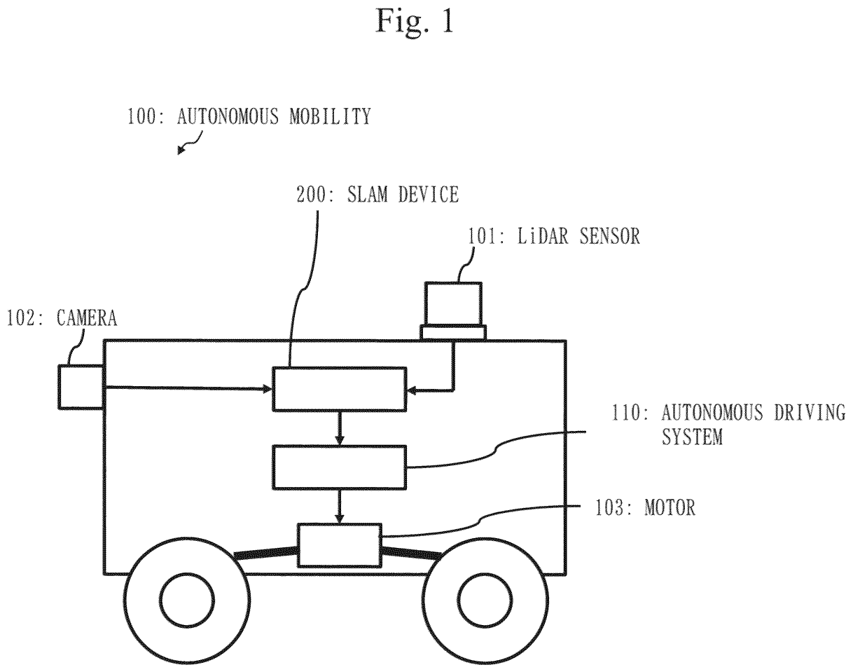

Autonomous mobility 100 will be described based on FIGS. 1 to 6.

### DESCRIPTION OF CONFIGURATION

Based on FIG. 1, a configuration of the autonomous mobility 100 will be described.

The autonomous mobility 100 is a vehicle that runs autonomously.

The autonomous mobility 100 is equipped with a LiDAR sensor 101 and a camera 102.

The LiDAR sensor 101 is a sensor that performs LiDAR, and is also called a laser scanner, a laser radar, or an optical radar. In LiDAR, laser light is emitted in each direction, reflected light from each point that has reflected the laser light is received, and a distance and a direction to each point that has reflected the laser light are measured.

The LiDAR sensor 101 can measure a surrounding area in a range of about 100 meters.

Data obtained by the LiDAR sensor 101 will be referred to as measurement point cloud data. The measurement point cloud data indicates a measurement point cloud. Specifically, the measurement point cloud data indicates a measurement distance and a measurement direction for each point where the laser light has been reflected (measurement point).

The camera 102 captures an image of the surrounding area and generates an image in which the surrounding area is captured.

Data obtained by the camera 102 will be referred to as image data. Image data indicates an image.

The autonomous mobility 100 includes a SLAM device 200.

The SLAM device 200 performs SLAM based on the measurement point cloud data. SLAM performs location estimation and map generation. Map generation includes map enlargement and map updating.

SLAM aids estimation of a self-location and thus can be utilized for a navigation function. When the speed in automated driving is taken into account, a map updating time interval of about 10 hertz is sufficient and a self-location estimation time interval of about 1 hertz is sufficient.

The SLAM device 200 uses image data to detect an attack on the LiDAR sensor 101. When an attack on the LiDAR sensor 101 is detected, the SLAM device 200 performs interpolation for SLAM based on the image data.

A specific example of an attack on the LiDAR sensor 101 is a light injection attack.

The SLAM device 200 has an object recognition function. The object recognition function detects obstacles in the traveling direction of the autonomous mobility 100 and obtains object detection information. The object detection information indicates objects that exist up to several hundred meters away.

The SLAM device 200 has a visual odometry function. The visual odometry function estimates the amount of movement (direction and distance) of the camera 102 based on a plurality of consecutive images, and records movement amount information. The movement amount information indicates how far and in which direction the camera 102 has moved in a specific coordinate system.

The autonomous mobility 100 includes an autonomous driving system 110 and a motor 103.

The autonomous driving system 110 drives the autonomous mobility 100 based on the map and the location.

The autonomous driving system 110 has a navigation function and a motor control function. The navigation function causes the autonomous mobility 100 to automatically arrive at a destination. The motor control function controls the motor 103, and records rotation information of wheels rotated by the motor 103. A scale coefficient, which indicates the scale of an actual space, is calculated based on the rotation information of the wheels.

The motor 103 is a drive device that moves the autonomous mobility 100.

The motor 103 rotates the wheels of the autonomous mobility 100, and transmits the rotation information of the wheels to the autonomous driving system 110.

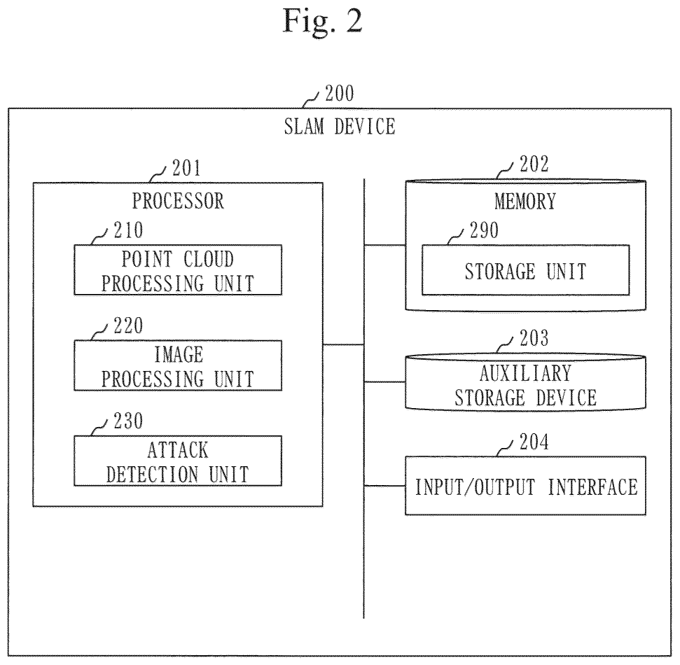

Based on FIG. 2, a configuration of the SLAM device 200 will be described.

The SLAM device 200 is a computer that includes hardware such as a processor 201, a memory 202, an auxiliary storage device 203, and an input/output interface 204. These hardware components are connected with one another through signal lines.

The processor 201 is an IC that performs operational processing and controls other hardware components. For example, the processor 201 is a CPU, a DSP, or a GPU.
IC is an abbreviation for integrated circuit.
CPU is an abbreviation for central processing unit.
DSP is an abbreviation for digital signal processor.
GPU is an abbreviation for graphics processing unit.

The memory 202 is a volatile or non-volatile storage device. The memory 202 is also called a main storage device or a main memory. For example, the memory 202 is a RAM. Data stored in the memory 202 is saved in the auxiliary storage device 203 as necessary.

RAM is an abbreviation for random access memory.

The auxiliary storage device 203 is a non-volatile storage device. For example, the auxiliary storage device 203 is a ROM, an HDD, a flash memory, or a combination of these. Data stored in the auxiliary storage device 203 is loaded into the memory 202 as necessary.

ROM is an abbreviation for read only memory.

HDD is an abbreviation for hard disk drive.

The input/output interface 204 is a port to which the LiDAR sensor 101, the camera 102, the autonomous driving system 110, and so on are connected.

The SLAM device 200 includes elements such as a point cloud processing unit 210, an image processing unit 220, and an attack detection unit 230. These elements are realized by software.

The auxiliary storage device 203 stores a SLAM attack countermeasure program to cause a computer to function as the point cloud processing unit 210, the image processing unit 220, and the attack detection unit 230. The SLAM attack countermeasure program is loaded into the memory 202 and executed by the processor 201.

The auxiliary storage device 203 further stores an OS. At least part of the OS is loaded into the memory 202 and executed by the processor 201.

The processor 201 executes the SLAM attack countermeasure program while executing the OS.

OS is an abbreviation for operating system.

Input data and output data of the SLAM attack countermeasure program are stored in a storage unit 290.

The memory 202 functions as the storage unit 290. However, a storage device such as the auxiliary storage device 203, a register in the processor 201, and a cache memory in the processor 201 may function as the storage unit 290 in place of the memory 202 or together with the memory 202.

The SLAM device 200 may include a plurality of processors as an alternative to the processor 201.

The SLAM attack countermeasure program can be recorded (stored) in a computer readable format in a non-volatile recording medium such as an optical disc or a flash memory.

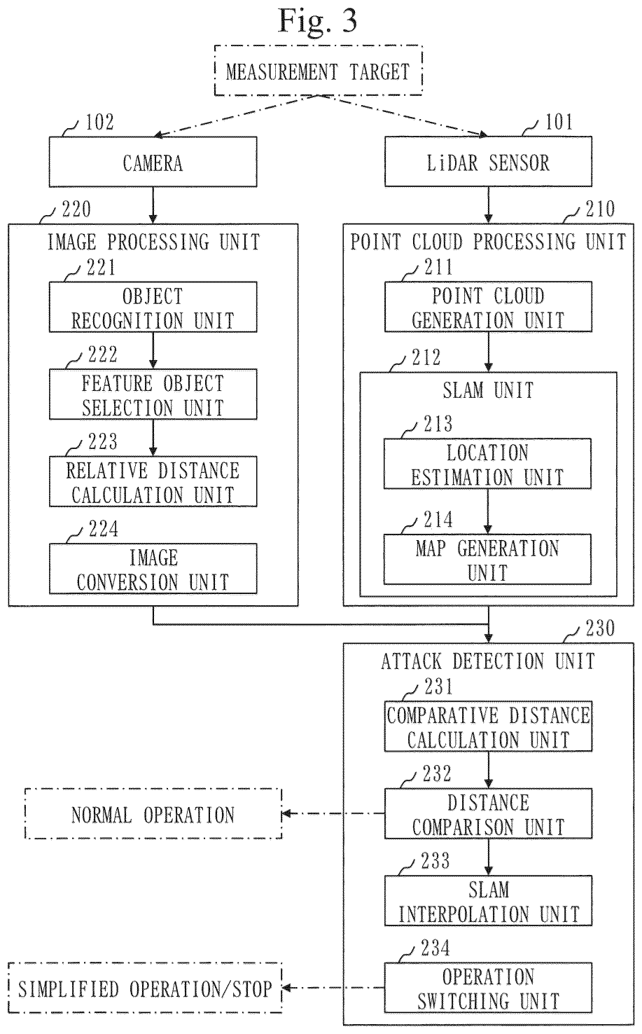

Based on FIG. 3, a functional configuration of the SLAM device 200 will be described.

The point cloud processing unit 210 includes a point cloud generation unit 211 and a SLAM unit 212.

The SLAM unit 212 includes a location estimation unit 213 and a map generation unit 214.

The image processing unit 220 includes an object recognition unit 221, a feature object selection unit 222, a relative distance calculation unit 223, and an image conversion unit 224.

The attack detection unit 230 includes a comparative distance calculation unit 231, a distance comparison unit 232, a SLAM interpolation unit 233, and an operation switching unit 234.

### DESCRIPTION OF OPERATION

A procedure for the operation of the SLAM device 200 is equivalent to a SLAM attack countermeasure method. The procedure for the operation of the SLAM device 200 is also equivalent to a procedure for processing by the SLAM attack countermeasure program.

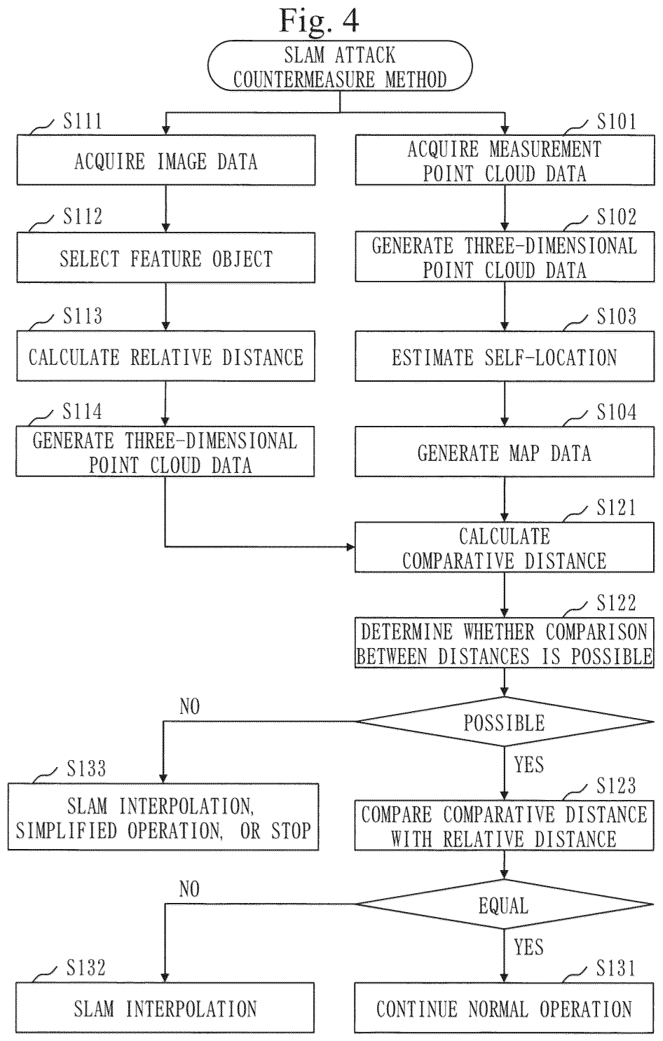

Based on FIG. 4, the SLAM attack countermeasure method will be described.

In step S101, the LiDAR sensor 101 performs measurement and generates measurement point cloud data.

The point cloud generation unit 211 acquires the measurement point cloud data from the LiDAR sensor 101.

The measurement point cloud data indicates a measurement distance and a measurement direction for each measurement point.

In step S102, the point cloud generation unit 211 generates three-dimensional point cloud data using a self-location and the measurement point cloud data. The generated three-dimensional point cloud data will be referred to as first three-dimensional point cloud data.

The three-dimensional point cloud data indicates a three-dimensional point cloud. The first three-dimensional point cloud data indicates three-dimensional coordinate values for each measurement point.

The three-dimensional coordinate values of a measurement point are calculated by adding a vector indicating the measurement distance and the measurement direction to three-dimensional coordinate values of the LiDAR sensor 101. The three-dimensional coordinate values of the LiDAR sensor 101 are determined based on a self-location.

In step S103, the location estimation unit 213 estimates a self-location by performing SLAM using the first three-dimensional point cloud data.

In step S104, the map generation unit 214 generates map data by performing SLAM using the first three-dimensional point cloud data.

The map data indicates a map of the surrounding area of the autonomous mobility 100. The map indicated in the map data is also called an environmental map or a SLAM map.

Step S103 and step S104 are performed in parallel in SLAM.

In step S111, the camera 102 captures an image and generates image data.

The object recognition unit 221 acquires the image data from the camera 102.

In step S112, the object recognition unit 221 performs object recognition processing using the image data. In the object recognition processing, image processing is performed on the image data and objects reflected on the image are recognized.

The feature object selection unit 222 selects a feature object from the recognized objects. Feature objects are determined in advance.

Specifically, the feature object selection unit 222 selects an object with specific features. The selected object is the feature object. The specific features are determined in advance.

A specific example of the feature object is a wall. Walls are objects that appear frequently and are also reflected in map data.

However, if the camera 102 is being attacked, the feature object may not be reflected on the image and thus the feature object may not be selected.

In step S113, the relative distance calculation unit 223 calculates a distance from the camera 102 to the feature object. The calculated distance will be referred to as a relative distance.

The wall (feature object) is considered to occupy a large part of the area of which the image is captured. The distance between the center of the wall in the area of which the image is captured and the camera 102 is the relative distance. The center of the wall is determined based on the outline of the wall.

The method for calculating a relative distance is the same as the method for calculating three-dimensional coordinate values in step S114.

However, if a feature object is not selected in step S112, step S113 is not performed and a relative distance is not calculated.

In step S114, the image conversion unit 224 converts the image data to generate three-dimensional point cloud data.

The image data is converted into three-dimensional point cloud data, as described below. The image conversion unit 224 calculates an angle at which an object reflected in each pixel is seen using the camera 102 as a base point, based on a viewing angle of the camera 102 and a distance from the center of the image to each pixel. The image conversion unit 224 performs this calculation operation twice. As a result, the three-dimensional coordinate values of the object are determined using the camera 102 as the base point. Then, the image conversion unit 224 generates data indicating the three-dimensional coordinate values of the object reflected in the pixel for each pixel. The generated data is three-dimensional point cloud data.

The generated three-dimensional point cloud data will be referred to as second three-dimensional point cloud data.

The second three-dimensional point cloud data indicates, for each pixel, the three-dimensional coordinate values of the point reflected in the pixel.

The processing in step S101 to step S104 and the processing in step S111 to step S114 are performed in parallel.

In step S121, the comparative distance calculation unit 231 calculates a distance from the self-location to the feature object on the map indicated in the map data, using the second three-dimensional point cloud data. The calculated distance will be referred to as a comparative distance.

The comparative distance is calculated as described below.

First, the comparative distance calculation unit 231 superimposes the three-dimensional point cloud indicated in the second three-dimensional point cloud data onto the map indicated in the map data. In other words, the comparative distance calculation unit 231 maps the three-dimensional point cloud onto the map.

Next, the comparative distance calculation unit 231 identifies a part of the map where the three-dimensional point cloud of the feature object is reflected (target part).

Then, the comparative distance calculation unit 231 calculates a distance from the self-location to the center of the target part. The calculated distance is the comparative distance.

However, if the LiDAR sensor 101 is being attacked, the feature object may not be indicated on the map and the comparative distance may not be calculated.

In step S122, the comparative distance calculation unit 231 determines whether a comparison between the relative distance and the comparative distance is possible.

If both the relative distance and the comparative distance are calculated, a comparison between the relative distance and the comparative distance is possible.

If a comparison between the relative distance and the comparative distance is possible, processing proceeds to step S123.

If a comparison between the relative distance and the comparative distance is not possible, processing proceeds to step S133.

In step S123, the distance comparison unit 232 compares the comparative distance with the relative distance.

If a difference between the comparative distance and the relative distance is within an allowable range, the distance comparison unit 232 determines that the comparative distance is equal to the relative distance. The allowable range is determined in advance.

The allowable range can be determined by statistical processing.

For example, the allowable range is a range equivalent to 3σ. “σ” is a confidence interval for the difference between the comparative distance and the relative distance when both the LiDAR sensor 101 and the camera 102 are not being attacked. 3σ is an interval three times the confidence interval σ.

When the maximum distance that the LiDAR sensor 101 can measure is approximately 100 meters, it is considered appropriate for the confidence interval σ to be between 1 meter and 10 meters.

When the confidence interval σ is 5 meters, 3σ is 15 meters.

If the difference between the comparative distance and the relative distance is equal to or greater than minus 7.5 meters or equal to or greater than plus 7.5 meters, the distance comparison unit 232 determines that the comparative distance is not equal to the relative distance.

If the comparative distance is equal to the relative distance, it is considered that the LiDAR sensor 101 is not being attacked. In this case, processing proceeds to step S131.

If the comparative distance is not equal to the relative distance, it is considered that the LiDAR sensor 101 is being attacked. In this case, processing proceeds to step S132.

In step S131, the SLAM device 200 continues normal operation.

The normal operation is a mode in which the point cloud processing unit 210, the image processing unit 220, and the attack detection unit 230 operate.

Specifically, the SLAM device 200 continues processing in the flow indicated in FIG. 4.

That is, processing proceeds to step S101 and step S111.

In step S132, the SLAM interpolation unit 233 interpolates the self-location and the map by performing interpolation for SLAM (SLAM interpolation).

Specifically, the SLAM interpolation unit 233 estimates a self-location using the visual odometry function. Then, the SLAM interpolation unit 233 updates the map by reflecting the three-dimensional point cloud indicated in the second three-dimensional point cloud data on the map based on the self-location.

After step S132, processing proceeds to step S101 and step S111.

In step S133, SLAM interpolation or operation switching is performed.

If the relative distance is calculated but the comparative distance is not calculated, it is considered that the camera 102 is not being attacked but the LiDAR sensor 101 is being attacked. In this case, the SLAM interpolation unit 233 performs SLAM interpolation. Then, processing proceeds to step S101 and step S111.

If the relative distance is not calculated, the operation switching unit 234 determines whether the feature object is indicated on the map.

If the feature object is indicated on the map, it is considered that the LiDAR sensor 101 is not being attacked but the camera 102 is being attacked. In this case, the operation switching unit 234 switches the operation of the SLAM device 200 from the normal operation to simplified operation. Then, the SLAM device 200 performs the simplified operation in place of the normal operation.

The simplified operation is a mode in which the point cloud processing unit 210 operates, but the image processing unit 220 and the attack detection unit 230 do not operate.

In the simplified operation, the SLAM device 200 continues only processing in step S101 to step S104.

If the relative distance is not calculated and the feature object is not indicated on the map, it is considered that both the LiDAR sensor 101 and the camera 102 are being attacked. In this case, the operation switching unit 234 stops the SLAM device 200. Then, the SLAM device 200 stops operating.

### DESCRIPTION OF IMPLEMENTATION EXAMPLE

Since LiDAR performs measurement based on the ToF principle using near-infrared light, it is difficult to perform measurement on a specific substance such as a mirror, glass, or black paint. Measurement may pass through the specific substance in an instant, or it may continue. If the specific substance is several meters long and the specific substance is measured only once, it is considered that even if a correct distance is not measured, this will not have an impact great enough to corrupt the map.

The SLAM device 200 may perform SLAM interpolation (step S132) not when the comparative distance is not equal to the relative distance once, but when the comparative distance is not equal to the relative distance a predetermined number of times in succession (for example, twice in succession). This can prevent erroneous operation.

If the autonomous mobility 100 is not equipped with other sensors and both the LiDAR sensor 101 and the camera 102 are being attacked, robust operation using sensor fusion is not possible.

The autonomous mobility 100 may be equipped with alternative sensors to replace the LiDAR sensor 101 and the camera 102 to make the sensor fusion more robust. A specific example of the alternative sensors is a radar and an IMU.

The radar is a sensor similar to the LiDAR sensor 101 and uses radio waves instead of laser light.

The IMU is a device used for inertial navigation and measures three-dimensional angular velocity and three-dimensional acceleration. Inertial navigation determines a location and velocity. IMU is an abbreviation for inertial measurement unit.

If both the LiDAR sensor 101 and the camera 102 are being attacked, the operation switching unit 234 switches the operation of the SLAM device 200 from the normal operation to alternative operation. Then, the SLAM device 200 performs the alternative operation in place of the normal operation.

The alternative operation is a mode in which the alternative sensors are used in place of the LiDAR sensor 101 and the camera 102.

In the alternative operation, the SLAM device 200 uses, for example, the alternative sensors in place of the LiDAR sensor 101 to perform processing of step S101 to step S104.

### Effects of Embodiment 1

Embodiment 1 relates to countermeasures against disturbance attacks on autonomous mobility driven by a navigation system using SLAM.

Embodiment 1 can detect disturbances to LiDAR and interpolate SLAM.

Embodiment 1 allows countermeasures to be implemented against light injection attacks on SLAM via LiDAR. As a result, safe driving of autonomous mobility can be provided.

As an existing technology, there is a method in which point cloud data from a camera is used to assist LiDAR. However, in the existing technology, it is difficult to determine whether the camera or LiDAR is attacked.

Embodiment 1 can facilitate this determination by comparing distances on a SLAM map.

### Features of Embodiment 1

The autonomous mobility 100 has the following functions.

The first function is to detect a distance to an object using the LiDAR sensor 101.

The second function is to detect a distance to an object using the camera 102.

The third function is to compare the two distances.

The fourth function is to perform interpolation for the self-location when the two distances are different. At this time, the fourth function interpolates an estimation of the self-location by comparing object detection information from the camera 102 with a SLAM map from the LiDAR sensor 101. The fourth function may perform switching to operation that relies on another sensor.

Since the object detection information and the SLAM map are compared directly, there is no difference between the map update interval and the attack detection interval. Therefore, countermeasures can be implemented while meeting the requirement for the map update interval.

### Supplement to Embodiment 1

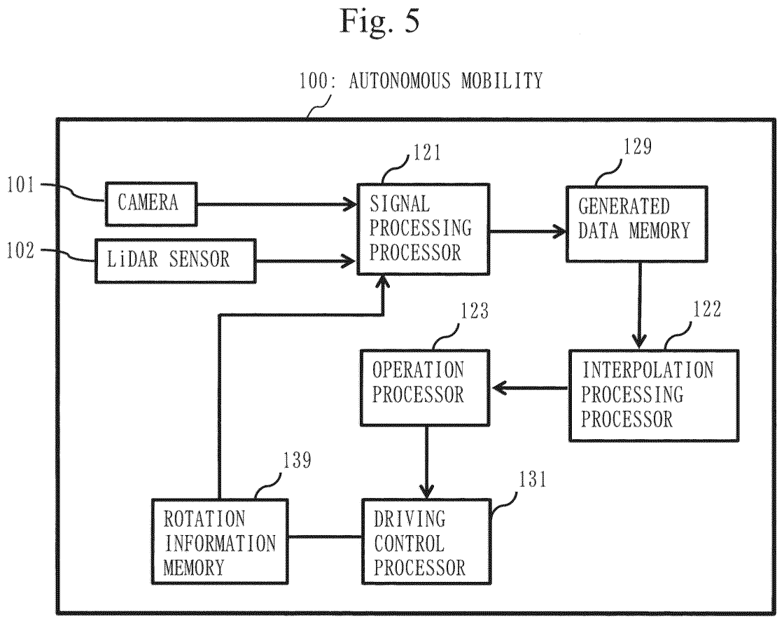

Based on FIG. 5, an example of a hardware configuration of the autonomous mobility 100 will be described.

The autonomous mobility 100 includes a signal processing processor 121, an interpolation processing processor 122, and a generated data memory 129.

The signal processing processor 121 corresponds to the processor 201, and performs step S101 to step S104 and step S111 to step S114.

The interpolation processing processor 122 corresponds to the processor 201, and performs step S121 to step S123 and step S131 to step S133.

The generated data memory 129 corresponds to the memory 202.

The autonomous mobility 100 includes a driving control processor 131 and a rotation information memory 139.

The driving control processor 131 is the processor of the autonomous driving system 110.

The rotation information memory 139 is the memory of the autonomous driving system 110.

### Supplement to the Embodiment

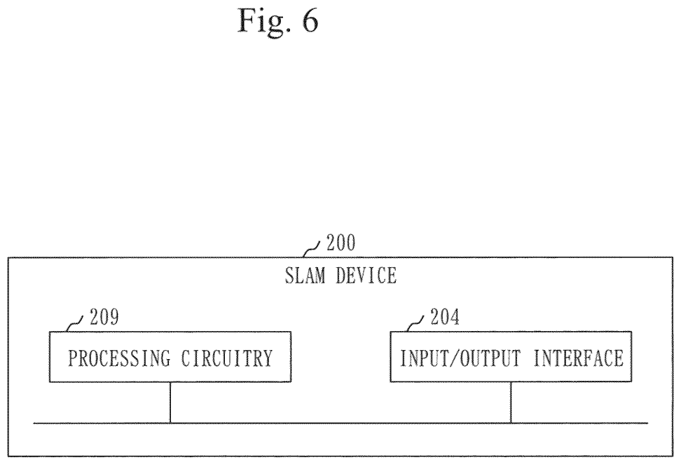

Based on FIG. 6, a hardware configuration of the SLAM device 200 will be described.

The SLAM device 200 includes processing circuitry 209.

The processing circuitry 209 is hardware that realizes the point cloud processing unit 210, the image processing unit 220, and the attack detection unit 230.

The processing circuitry 209 may be dedicated hardware, or may be the processor 201 that executes programs stored in the memory 202.

When the processing circuitry 209 is dedicated hardware, the processing circuitry 209 is, for example, a single circuit, a composite circuit, a programmed processor, a parallel-programmed processor, an ASIC, an FPGA, or a combination of these.

ASIC is an abbreviation for application specific integrated circuit.

FPGA is an abbreviation for field programmable gate array.

The SLAM device 200 may include a plurality of processing circuits as an alternative to the processing circuitry 209.

In the processing circuitry 209, some functions may be realized by dedicated hardware and the remaining functions may be realized by software or firmware.

As described above, the functions of the SLAM device 200 can be realized by hardware, software, firmware, or a combination of these.

Embodiment 1 is an example of a preferred embodiment, and is not intended to limit the technical scope of the present disclosure. Embodiment 1 may be partially implemented or may be implemented in combination with another embodiment. The procedures described using flowcharts or the like may be suitably changed.

Each “unit” that is an element of the SLAM device 200 may be interpreted as “process”, “step”, “circuit”, or “circuitry”.

### REFERENCE SIGNS LIST

100: autonomous mobility, 101: LiDAR sensor, 102: camera, 103: motor, 110: autonomous driving system, 121: signal processing processor, 122: interpolation processing processor, 123: operation processor, 129: generated data memory, 131: driving control processor, 139: rotation information memory, 200: SLAM device, 201: processor, 202: memory, 203: auxiliary storage device, 204: input/output interface, 209: processing circuitry, 210: point cloud processing unit, 211: point cloud generation unit, 212: SLAM unit, 213: location estimation unit, 214: map generation unit, 220: image processing unit, 221: object recognition unit, 222: feature object selection unit, 223: relative distance calculation unit, 224: image conversion unit, 230: attack detection unit, 231: comparative distance calculation unit, 232: distance comparison unit, 233: SLAM interpolation unit, 234: operation switching unit, 290: storage unit.

1. A SLAM device that is installed in autonomous mobility equipped with a LiDAR sensor and a camera, the SLAM device comprising
processing circuitry to perform:
point cloud processing of acquiring measurement point cloud data from the LiDAR sensor, generating first three-dimensional point cloud data based on the measurement point cloud data, and performing SLAM using the first three-dimensional point cloud data so as to estimate a location and generate a map;
image processing of acquiring image data from the camera, recognizing a feature object in an image indicated in the image data, calculating a distance from the camera to the feature object as a relative distance, and converting the image data into second three-dimensional point cloud data; and
attack detection of superimposing a three-dimensional point cloud indicated in the second three-dimensional point cloud data onto the generated map so as to calculate a distance from the estimated location on the map to the feature object as a comparative distance, comparing the comparative distance with the relative distance, and when a difference between the comparative distance and the relative distance is a value outside an allowable range, performing interpolation for the SLAM using the second three-dimensional point cloud data.

2. The SLAM device according to claim 1,
wherein in the attack detection, the processing circuitry performs the interpolation not when the difference is a value outside the allowable range only once, but when the difference is a value outside the allowable range a predetermined number of times in succession.

3. The SLAM device according to claim 1,
wherein in the attack detection, the processing circuitry performs, as the interpolation, estimation of the location by visual odometry and updating of the map using the second three-dimensional point cloud data.

4. The SLAM device according to claim 3,
wherein in the attack detection, the processing circuitry performs the interpolation when the comparative distance cannot be calculated and thus the comparative distance cannot be compared with the relative distance.

5. The SLAM device according to claim 1,
wherein in the attack detection, the processing circuitry switches operation of the SLAM device to simplified operation when the comparative distance is not calculated and thus the comparative distance cannot be compared with the relative distance and when the feature object is indicated on the map, and
wherein the simplified operation is a mode in which the point cloud processing is performed, but the image processing and the attack detection are not performed.

6. The SLAM device according to claim 1,
wherein in the attack detection, the processing circuitry stops the SLAM device when the comparative distance is not calculated and thus the comparative distance cannot be compared with the relative distance and when the feature object is not indicated on the map.

7. The SLAM device according to claim 1,
wherein the SLAM device is equipped with an alternative sensor to replace the LiDAR sensor,
wherein in the attack detection, the processing circuitry switches operation of the SLAM device to alternative operation when the comparative distance is not calculated and thus the comparative distance cannot be compared with the relative distance and when the feature object is not indicated on the map, and
wherein the alternative operation is a mode in which the alternative sensor is used in place of the LiDAR sensor.

8. The SLAM device according to claim 1,
wherein the feature object is a wall.

9. A non-transitory computer readable medium storing a SLAM attack countermeasure program for a computer that is installed in autonomous mobility equipped with a LiDAR sensor and a camera, the SLAM attack countermeasure program causing the computer to execute:
a point cloud process of acquiring measurement point cloud data from the LiDAR sensor, generating first three-dimensional point cloud data based on the measurement point cloud data, and performing SLAM using the first three-dimensional point cloud data so as to estimate a location and generate a map;
an image process of acquiring image data from the camera, recognizing a feature object in an image indicated in the image data, calculating a distance from the camera to the feature object as a relative distance, and converting the image data into second three-dimensional point cloud data; and
an attack detection process of superimposing a three-dimensional point cloud indicated in the second three-dimensional point cloud data onto the generated map so as to calculate a distance from the estimated location on the map to the feature object as a comparative distance, comparing the comparative distance with the relative distance, and when a difference between the comparative distance and the relative distance is a value outside an allowable range, performing interpolation for the SLAM using the second three-dimensional point cloud data.

10. Autonomous mobility comprising:
a LiDAR sensor to perform measurement and generate measurement point cloud data;
a camera to capture an image and generate image data;
a SLAM device to estimate a location and generate a map based on the measurement point cloud data; and
an autonomous driving system to perform autonomous driving based on the estimated location and the generated map,
wherein the SLAM device includes
processing circuitry to perform:
point cloud processing of acquiring the measurement point cloud data from the LiDAR sensor, generating first three-dimensional point cloud data based on the measurement point cloud data, and performing SLAM using the first three-dimensional point cloud data so as to estimate the location and generate the map;
image processing of acquiring the image data from the camera, recognizing a feature object in an image indicated in the image data, calculating a distance from the camera to the feature object as a relative distance, and converting the image data into second three-dimensional point cloud data; and
attack detection of superimposing a three-dimensional point cloud indicated in the second three-dimensional point cloud data onto the generated map so as to calculate a distance from the estimated location on the map to the feature object as a comparative distance, comparing the comparative distance with the relative distance, and when a difference between the comparative distance and the relative distance is a value outside an allowable range, performing interpolation for the SLAM using the second three-dimensional point cloud data.
